(19) United States
(12) Patent Application Publication
(10) Pub. No.: US 2006/0243404 A1
(43) Pub. Date: Nov. 2, 2006

(54) Method and device for producing a web of tissue

(76) Inventors: Thomas Scherb, Sao Paulo -SP (BR); Lulz Carlos Silva, Campo Limpo-SP (BR)

Correspondence Address: GREENBLUM & BERNSTEIN, P.L.C., 1950 ROLAND CLARKE PLACE, RESTON, VA, 20191, US

(21) Appl. No.: 10/560,074

(22) PCT Filed: Jun. 9, 2004
(86) PCT No.: PCT/EP04/51070

§ 371 Date: Jun. 23, 2006

(30) Foreign Application Priority Data
Jun. 11, 2003 (DE) 10326304.7

(51) Int. Cl. D21F 11/00; B31F 1/12

(52) U.S. Cl. 162/111; 162/280; 162/193

(57) ABSTRACT

Method and device for producing a web of tissue. In the method, the web of tissue is led over at least one drying cylinder, doctored off the latter with a creping doctor and then wound up by way of a winding device. The web of tissue is supported at least largely over the entire distance between creping doctor and winding device on one side by a transfer device, so that there is only a short free web draw, while its other side is free. The device includes at least one drying cylinder, a creping doctor arranged on the drying cylinder and a winding device that winds up the web of tissue. Between the creping doctor and the winding device, a transfer device at least largely bridges the entire distance which supports the web of tissue on one side. There is a short free web draw, but its other side is left free.

The present invention relates to a method for producing a web of tissue, in which the web of tissue is led over at least one drying cylinder, doctored off the latter with a creping doctor and then wound up by means of a winding device.

Furthermore, the present invention relates to a device for producing a web of tissue, having at least one drying cylinder, a creping doctor arranged on the drying cylinder and a winding device for winding up the web of tissue.

The aforementioned web of tissue can in particular be tissue grades such as toilet paper, cleaning cloths for the face, napkin paper and the like. In particular in the case of these grades of tissue, what is concerned, inter alia, are the specific volume (“bulk”, measured in cm³/gm), which should be as high as possible, and what is known as the “hand feel”, which is a measure of how pleasant the tissue feels when handled. Since this measure depends on the subjective sense of the user, there is as yet no objective measurement method. Properties such as softness, velvetiness and a flat surface topography promote a high degree of “hand feel”. A “hand feel” value is determined as a result of the subjective assessment of a large number of testing persons.

In addition a certain minimum strength, which matches the requirements of the user, is important for a tissue product.

A number of concepts for tissue machines have already been proposed which, in general, have the object of improving the tissue properties.

The object of the present invention is to provide an improved method and an improved device of the type mentioned at the beginning. In particular, the quality of the tissue, the production speed and the runability of the device are to be improved.

In a method of the type mentioned at the beginning, this object is achieved in that the web of tissue is supported at least largely over the entire distance between creping doctor and winding device on one side by a transfer means, so that there is in any case only a short free web draw, while its other side is free.

In a device of the type mentioned at the beginning, this object is achieved in that, between the creping doctor and winding device, a transfer means that at least largely bridges the entire distance is provided which supports the web of tissue on one side, so that there is in any case only a short free web draw, but leaves its other side free.

It has been shown that, as a result of supporting the web of tissue with a transfer means between creping doctor and winding device, the runability and the speed of the device can be increased considerably and the quality of the tissue can be improved considerably. On the basis of the development of high-performance hoods, the size of the drying cylinder nowadays is no longer the bottleneck with respect to runability and machine speed in tissue machines. Instead, the difficulty consists in the handling of the free web draw which, in the case of known machines, is attempted to be solved with various threading systems between creping doctor and winding drum.

In a departure from this, the web of tissue, as mentioned, is supported, according to the invention, such that there is any case only a short free web draw. As a result, the problems occurring in the case of long free web draws can be avoided. Here, according to the invention, it has been found that one-sided supporting of the web of tissue is sufficient and the other side of the web of tissue can remain free. This leads to a cost-effective solution and also reduces the susceptibility of the device to faults.

On account of the one-sided supporting of the web of tissue with a-maximum free web draw of preferably <1 m, in particular <0.5 m, the result is additionally the possibility of reducing the line force in the winding nip as compared with known methods and devices. For instance, the line force can be reduced from 0.8 kN/m to 0.2 kN/m and less. As a result of this reduction in the line force, with the same hand feel and the same creping structure, a higher specific volume can be achieved or, given the same specific volume, a finer creping structure and a considerably improved hand feel can be achieved. It is also possible to wind up larger jumbo rolls.

As a further advantage, it has been established that the device operates more cleanly, exhibits less paper loss and that the paper can be led off directly when threaded into the pulper.

The method is particularly suitable for use in the case of tissue with a low basis weight and/or low tensile strength.

A suitable structure results if the transfer means is arranged on the underside of the web of tissue and in particular begins underneath the creping doctor.

According to the invention, the transfer means used can in particular be a belt, an embossing belt, a felt, an embossing felt, a membrane or a fabric. In this case, the transfer means is preferably led through the winding nip of the winding device with the web of tissue. In this way, the supporting of the web of tissue is carried out until the latter is transferred to the spool, so that, in any case during the transfer from the drying cylinder, there is a short free web draw.

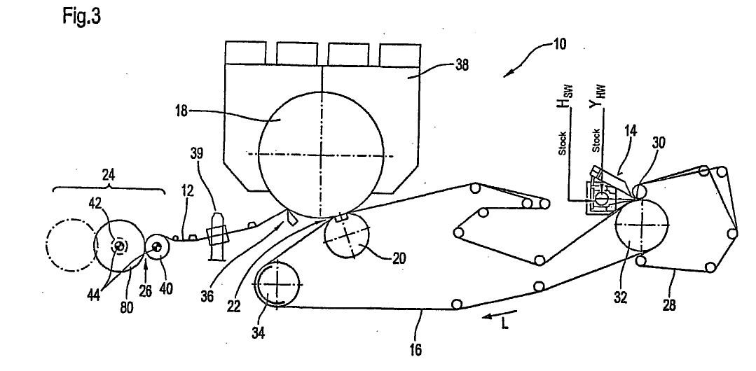

The membrane used can in particular be a Spectra membrane, as described, for example, in GB 2 305 156 A in conjunction with FIG. 3 there and also in GB 2 235 705 B. The two aforementioned documents are hereby incorporated by reference in the content of the present application.

The transfer means used can be a transfer belt, in particular a TAD belt, which is produced by weaving. The fabric forming the transfer belt is distinguished by specific parameters, which can be varied in order to design the transfer belt specifically for the respective intended purpose and in order to achieve specific effects.

These parameters include, for example, the height of the knuckles, at which the warp threads and weft threads lie on one another, the percentage of the area assumed by these knuckles (knuckle area), the type of woven fabric and the permeability.

The height of the knuckles can lie in the range from 0.15 to 0.7 mm and, in a preferred exemplary embodiment, is 0.35 mm.

The area occupied by the knuckles (knuckle area) preferably lies in the range from 7% to 30% and is preferably 25%. The permeability preferably lies in the range from 500 cfm to 750 cfm and is preferably 650 cfm.

In the following table, characteristics of various types of woven fabric which are suitable for TAD belts are specified. The thickness of the woven fabric can be reduced, for example by half, in a further operation by means of a grinding or lapping.

| | | | M-Weave | | | | G-Weave | | |
|---|---|---|---|---|---|---|---|---|---|
| Fabric type | DSP 352 | Q-625 | 36-Mesh | 44-Mesh | 44-Mesh | 58-Mesh | 44-Mesh | 44-Mesh | 50-Mesh |
| No. of meshes | 49 × 40 | 48 × 16 | 36 × 32 | 42 × 28 | 42 × 32 | 58 × 44 | 42 × 31 | 43 × 34 | 53 × 43 |
| (/inch) | | | | | | | | | |
| Warp threads | 0.35 | 0.27 × 0.56 | 0.40 | 0.35 | 0.35 | 0.27 | 0.35 | 0.35 | 0.30 |
| (mm) | | (smooth yarns) | | | | | | | |
| Weft threads | 0.40 | 0.70 | 0.41 | 0.45 | 0.41 | 0.35 | 0.45 | 0.41 | 0.35 |
| (mm) | | | | | | | | | |
| Caliper or thickness | 0.049 | 0.0528 | 0.037 | 0.039 | 0.036 | 0.031 | 0.035 | 0.033 | 0.030 |
| (inch) | (unground) | | | | | | | | |
| Permeability | 650 | 625 | 725 | 525 | 525 | 625 | 600 | 600 | 650 |
| (cfm) | | | | | | | | | |
| Fiber support index | | | 45/40 | 51/47 | 57/49 | 65/60 | 55 | 59 | 63 |
| (FSI) | | | | | | | | | |
| Percentage of open area | 17.8% | | | | | | | | |

According to further refinement of the invention, which is also claimed independently, the web of tissue is subjected to a patterning process in the winding nip. As a result of this patterning process in the winding nip, the quality of the tissue is likewise improved, in particular in that a large part of the tissue remains unpressed during the winding operation or is pressed only slightly.

In order to achieve such a patterning process in the winding nip, it is preferred to use a structured material, in particular a TAD belt, as the transfer means. If this TAD belt is led through the winding nip together with the web of tissue, pressing of the web of tissue during the winding process is carried out substantially only in the elevated regions of the belt which, for example, make up only about 25% of the total web area. Therefore, about 75% of the web of tissue remains unpressed or only slightly pressed, which results in the aforementioned quality advantages. In this way, for example, a line force in the winding nip is reduced from 0.8 kN/m to 0.2 kN/m. The hand feel and the creping structure which can be achieved are correspondingly good.

Particularly good results could be achieved with a line force in the winding nip reduced to about 0.2 kN/m or below. In principle, a reduction to virtually 0 kN/m is possible with the method according to the invention.

According to a further refinement of the invention, which is likewise also claimed independently, the web of tissue is subjected to wet forming between drying cylinder and winding device. The quality of the tissue can also be improved in this way.

The wet forming can in particular be implemented by the web of tissue being rewetted and having vacuum applied to it in the supported region. As a result of the wetting and application of vacuum, advantageous wet forming can be carried out, as described in the as yet unpublished PCT application number PCT/US03/02108 bearing the priority date Jan. 24, 2002.

Wetting of the web of tissue can be carried out before or at the same time as the application of vacuum. It is preferred for the web of tissue to be wetted on its upper side and to have vacuum applied to its underside. Particularly good wet forming can be achieved thereby.

In order to avoid an excessively high moisture of the web of tissue after the wet forming, the latter can than be dried again, for example by means of infrared, a drying hood and/or at least one drying cylinder.

Good results could be achieved if the dryness at the creping doctor was chosen to be between about 70 and about 100%, in particular between about 93% and about 98%. However, it is also possible to operate with moist crepe, that is to say with a web of tissue which is moist at the creping doctor, in particular has a moisture level between 94% and 98% or a moisture level of up to 70%.

The creping rate is preferably chosen to be between about 0% and about 50%, in particular between about 10% and about 25%. Particularly good results could also be achieved hereby.

According to a further refinement of the invention, the production of the web of tissue is carried out without a threading system. On the basis of the method according to the invention, it is possible to dispense with threading systems, which has advantages with regard to costs and runability.

In order to support the transfer of the web of tissue onto the transfer means, according to a further refinement of the invention, vacuum is preferably applied to said web. The application of vacuum can in particular be carried out by a suction roll after the creping doctor.

Another possible way of supporting the transfer of the web of tissue to the transfer means is to blow on the web of tissue after the creping doctor. Various blowing means, for example air jets, can be provided for this purpose.

Threading onto the winding drum can be carried out as in the case of conventional winding drums. As a result, specific means are not required.

The winding drum used can be an uncovered or covered roll. Rubber, for example, is suitable as a cover.

Furthermore, a winding drum with a smooth shell, a blind-drilled shell, a drilled shell or a shell provided with grooves can be used. As a result of this open configuration of the roll surface, an influence can be exerted on the air flow around the winding drum and, as a result, the latter can be improved.

A further improvement can be achieved by blowing off paper into a pulper under the winding drum. A pulper can also be used underneath the drying cylinder. The blowing-off action can be carried out, for example, by an air knife or an air shower.

It is likewise advantageous if an air deflector or doctor is used on the winding drum in order to prevent air carried along by the winding drum getting back to the web of tissue.

The present invention can also be combined with an invention for which application was made earlier, whose object is to provide an improved method and an improved tissue machine of the type mentioned at the beginning with which a tissue product or tissue paper, in particular “toilet tissue” and “facial tissue” with a particularly high “hand feel” and high specific volume (bulk) with acceptable strength is ensured. In the case of a “facial tissue” with a mass per unit area of, for example, 15 g/m², the aim is a specific volume (bulk) of 10 cm³/g and higher, and, in the case of a mass per unit area of 23 g/m², the aim is a specific volume (bulk) of 9.0 cm³/g and higher. In addition, the construction of the relevant tissue machine should be as simple and cost-effective as possible. At the same time, it should be possible to produce as many different product grades as possible on this machine.

According to the earlier invention, this object is achieved by a method for producing a web of tissue by means of a tissue machine having a headbox and an endless carrier belt, with which the web of tissue is led to a press nip formed between a drying cylinder and a backing unit, the headbox used being a multilayer headbox, at least two grades of stock being supplied to this multilayer headbox and the tissue web being wound up by means of a winding device after the press nip, the hardness of the roll produced preferably being influenced in a predefined way, in particular controlled and/or regulated.

In this case, the drying cylinder used is preferably a Yankee cylinder.

The line force produced in the winding nip is expediently chosen to be less than or equal to 0.8 kN/m.

According to a preferred practical refinement of the method according to the invention, a former having two circulating endless belts is used, which run together, forming a stock inlet gap, and are then led over a forming element, such as in particular a forming roll, the inner belt coming into contact with the forming element preferably forming the transport belt. Use is preferably made of a Crescent former, whose inner belt is formed by a felt.

It is also advantageous in particular if the web of tissue is led through at least one shoe press together with the carrier belt. In this case, a shoe press unit is expediently used as the backing unit assigned to the drying cylinder.

A high-temperature hood can be provided over the drying cylinder or Yankee cylinder.

A further improvement in the tissue product properties can also be achieved in particular by the web of tissue being doctored off the drying cylinder by means of a creping doctor, in particular a thin creping doctor.

Use is preferably made of one or more of the following grades of stock:
Hardwood fibers, in particular short-fiber chemical pulps
Softwood fibers, in particular long-fiber chemical pulps
CTMP (chemical-thermo mechanical pulp).

Mixtures of grades of stock are preferred in which the proportion of hardwood fibers lies in a range from about 50% to about 80%, the proportion of softwood fibers lies in a range from about 20% to about 50%, and/or the proportion of CTMP (chemical-thermo mechanical pulp) lies in a range from 0% to about 20%.

Thus, inter alia, for example the following mixtures of grades of stock are conceivable:

| | Ex. “a” | Ex. “b” | Ex. “c” |
|---|---|---|---|
| Hardwood (50 to 80%) | 50 | 60 | 70 |
| Softwood (20 to 50%) | 30 | 40 | 20 |
| CTMP (0 to 20%) | 20 | 0 | 10 |

Here, in particular the CTMP in a respective mixture of grades of stock improves the specific volume (bulk).

According to a preferred practical refinement of the method according to the invention, the web of tissue is led around the drying cylinder after the press nip, the drying in the relevant wrap region preferably being intensified by a drying hood, in particular a high-temperature hood.

It is of particular advantage if at least two different grades of stock are supplied to the multilayer headbox and, in this case, short fibers obtained from hardwood are used for the layer of the web of tissue facing the drying cylinder surface, and long fibers obtained from softwood are used for the layer provided on the opposite web side.

It is therefore of particular advantage if the headbox is loaded with at least two layers with different fibrous stocks, the stock with the short fibers obtained from hardwood being added in the layer of the headbox which forms the side of the web of tissue facing the drying or Yankee cylinder surface. The second layer is expediently loaded with long fibers from softwood. Alternatively or additionally, this second layer can also be loaded with long fibers and CTMP and/or with long fibers and also CMP and short fibers. This layer forms the second ply of the web of tissue and faces the drying hood in the drying process. It therefore never comes into contact with the drying or Yankees cylinder surface. By using these method steps, the “hand feel” and “bulk” values are improved by about 5% and more.

A multilayer headbox is preferably used, whose nozzle is subdivided into at least two channels by at least one slat extending over the entire machine width. In this case, the nozzle is expediently subdivided at least substantially symmetrically into two channels by a slat.

Particularly good results are achieved if the slat extends outward beyond the nozzle in the region of the outlet gap. In this way, mixing of the layers is counteracted.

A headbox having sectional dilution water regulation and/or control over the machine width can advantageously be used, in order to be able to establish a respectively desired transverse grammage profile.

In specific cases, it is advantageous if, for at least two layers, dilution water regulation and/or control is provided in each case. For example, when a two-layer headbox is used, it is therefore possible, if appropriate, for dilution water regulation or control to be provided in each case in the two layers.

Dilution water regulation and/or control is preferably provided at least for the layer facing the forming or breast roll. In this case, therefore, relevant dilution water regulation and/or control can in particular also be provided only for this one layer, that is to say the outer layer with respect to the forming or press roll. The forming or press roll can be closed, open or else evacuated.

The drying of the web by the drying or Yankee cylinder and a drying or hot air hood are important for the drying process, according to a preferred practical refinement of the method according to the invention, the proportion of the drying provided by the drying hood for drying the web of tissue being chosen to be higher than the proportion of the drying provided by the drying cylinder.

In this case, the ratio between the proportion of the drying of the drying hood and the proportion of the drying of the drying cylinder is advantageously chosen to be greater than 55:45, in particular greater than or equal to 60:30, in particular greater than or equal to 65:35 and preferably greater than or equal to 70:30.

The drying hood is preferably operated at a temperature which is greater than or equal to 400° C., in particular greater than or equal to 500° C., in particular greater than or equal to 600° C. and preferably greater than or equal to 700° C.

The steam pressure in the drying cylinder can additionally be lowered. Thus, a value for the steam pressure in the drying cylinder is advantageously chosen which is less than or equal to 0.7 MPa, in particular less than or equal to 0.6 MPa and preferably less than or equal to 0.5 MPa.

As a result, the course of the drying can be increased further. By means of the aforementioned measures, an increase in the “bulk” value by up to +5% and an improvement in the “hand feel” value are achieved.

Particular importance is also placed in particular on the winding of the web of tissue at the end of the tissue machine.

According to a preferred practical refinement of the method according to the invention, a winding device (reeler) is used in which the web of tissue is led over a carrier drum and is then wound up onto a spool, both the carrier drum and the spool preferably each being assigned a drive. As a result, optimal winding of the web is ensured without destroying the specific volume (bulk) of the paper web produced. Thus, with the use of two drives for the carrier drum and the spool or the wound roll, in particular a reduction in the line force produced in the winding nip is possible.

According to an expedient practical refinement of the method according to the invention, the line force produced in the winding nip between the carrier drum and the spool is chosen to be less than or equal to 0.8 kN/m, in particular less than or equal to 0.5 kN/m and preferably less than or equal to 0.2 kN/m. Since no drive power has to be transmitted between the carrier drum and the wound roll, the pressure in the winding nip or contact nip can be reduced.

Since tissue paper is creped, has a high stretch, that is to say a high modulus of elasticity, and a low tensile strength, no substantial web draw can be applied in order to increase the winding hardness of the wound roll.

The maximum difference between the circumferential speed of the roll and the circumferential speed of the carrier roll is preferably less than 10% of the circumferential speed of the carrier roll.

According to a preferred practical refinement of the method according to the invention, the web draw between the drying cylinder and the carrier drum is set to a predefinable desired value, in particular controlled and/or regulated, via the drive assigned to the carrier drum, irrespective of the line force produced in the winding nip.

Because of the creping on the creping doctor, the carrier drum circumferential speed is lower than the circumferential speed of the drying cylinder.

Advantageously, the drive assigned to the spool is controlled and/or regulated as a function of the speed of the carrier drum.

Of particular importance during the production of a soft roll is the monitoring of the “low” line force in the winding nip or contact nip. According to a preferred practical refinement of the method according to the invention, for this purpose a winding device is used in which the carrier drum is mounted in a fixed position and the spool can be moved. Accordingly, the growth of the roll diameter can be compensated for by means of an appropriate movement of the spool. In addition, the line force in the winding nip can be set in the desired way via the movable spool. A common control loop can advantageously be used to compensate for the roll diameter growth and in order to set the line force in the winding nip. An expedient refinement of the method according to the invention is distinguished by the fact that the line force in the winding nip is determined via at least one force sensor and this line force is regulated by means of moving the spool appropriately. In principle, however, for example the spool can also be fixed in position and the carrier drum can be movable. Furthermore, designs in which both the carrier drum and the spool can be moved are also conceivable.

It is possible that, in the case of low line forces and large, heavy wound rolls, the measurement accuracy of the sensors and the setting accuracy (friction) are no longer sufficient. In particular in the case of line forces in the winding nip which are less than or equal to 0.5 kN/m and in particular less than or equal to 0.2 kN/m, the movable spool is therefore preferably displacement-controlled. In this case, in particular the roll diameter and the position of the spool or the roll formed on the latter relative to the carrier drum are used as measured variables for the displacement control.

According to a further advantageous refinement of the method according to the invention, for the purpose of setting and controlling and/or regulating the line force in the winding nip, the region of the winding nip can be monitored appropriately by means of a CCD camera. In this case, by means of the CCD camera, the respective distance between the carrier drum and the spool or the roll formed on the latter is preferably registered.

By using such an observation of the winding nip region, for example by means of a CCD camera, a further possible way of monitoring and setting the winding force therefore results. It is therefore possible to measure and display the distance between the carrier drum and the wound roll. By using an evaluation of the image, a desired value for the hydraulic cylinder pressure influencing the movable wound roll can then be achieved and the translation or displacement as far as the desired distance or winding force can be carried out via a control device. The gain in bulk can, for example, lie in a range from 4 to 8%. A further advantage is that the gain in “bulk” reached by means of the shoe press is not destroyed and thus the quality of the web is maintained.

It is also advantageous in particular if the drive assigned to the spool and therefore to the wound roll is not changed during the winding operation, that is to say in particular not even if the new spool is moved from the spool store via the primary or winding position, in which the drive is coupled up and the spool is accelerated, to the secondary position on the rails. The result is therefore controlled winding from the start to the end.

The paper quality can be increased further by the mass per unit area of the web of tissue in the uncreped state lying in a range from about 11 g/m² to about 20 g/m² and in the creped state lying in a range from about 14 g/m² to about 24 g/m².

Since, above all, in the case of thin papers and in particular in the case of “facial tissue” and “toilet” tissue, the formation, that is to say the uniformity of the fiber arrangement, plays an important part, the use of a Crescent former is of particular advantage in these cases in particular. In this case, the web is dewatered, transported, pressed and passed onto the drying cylinder or Yankee cylinder on a felt. At the start of dewatering, an outer fabric is also provided. In addition to improved formation, the result is also improved strength with possible tearing length ratios longitudinally/transversely of 1:1 to 4:1. This makes it possible to beat the fibers less. This increases the “bulk” value. By means of this former type, “strength” can be converted into “bulk”. This former type improves the specific volume (bulk) by +5% in combination with at least one of the design variants described.

In this case, use can be made in particular of a Crescent former whose inner or carrier belt, formed by a felt, together with the web of tissue, is led over at least one evacuated device before the press nip in the web running direction. The evacuated device provided can be in particular a suction roll. As already mentioned, the outer belt provided in the region of the forming element of the Crescent former can in particular be formed by a wire fabric.

Also of particular advantage is, in particular, the use of a shoe press having a shoe length measured in the web running direction of greater than or equal to 80 mm and preferably greater than or equal to 120 mm. By means of the shoe press, a line force which lies in a range from 60 kN/m to about 90 kN/m is preferably produced. The maximum pressing pressure in the press nip of the shoe press is preferably less than or equal to 2 bar and preferably less than or equal to 1.5 bar. Moreover, the shoe press can comprise a shoe press unit having a blind-drilled press shell. As compared with a suction press roll, a gain in bulk in a range from about 15% to about 20% can therefore be achieved.

According to an expedient practical refinement of the method according to the invention, a drying cylinder or Yankee cylinder provided with reinforcing ribs in the interior is used, as a result of which the line force produced in the press nip can also be increased substantially above 90 kN/m. This makes the tissue machine more flexible, in particular for the case in which, in addition to the “facial” and “toilet” tissue papers, tissue grades are also run in which the “hand feel” and the specific volume (bulk) do not have first priority but the dryness, that is to say the production level, does.

As already mentioned, a relatively thin creping doctor is preferably used. In this case, the thickness of the creping doctor can in particular be less than or equal to 0.9 mm.

The angle of attack between the tangent to the drying cylinder and the creping doctor is preferably less than or equal to 20°.

In the case of this creping doctor, what is known as the “rake angle” can in particular be greater than or equal to 15°.

According to the invention, the object specified at the beginning can, moreover, be achieved by a machine for producing a web of tissue having a headbox and an endless carrier belt, with which the web of tissue is led through a press nip formed between a drying cylinder and a backing unit, and having a winding device for subsequently winding up the web of tissue, the headbox provided being a multilayer headbox, to which at least two grades of stock can be supplied, and means preferably being provided in order to influence, in particular to control and/or regulate, the hardness of the roll produced in a predefined way as the web of tissue is wound up.

Preferred embodiments of the tissue machine according to the invention are specified in the subclaims.

Nonrestricting exemplary embodiments of the invention are illustrated in the drawing and will be described below. In each case in a schematic illustration:

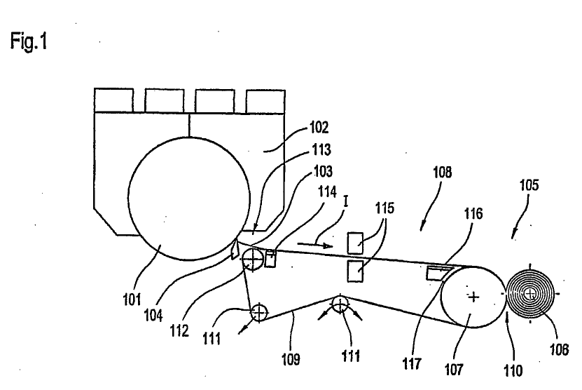

FIG. 1 shows part of a device according to the invention in a first variant,

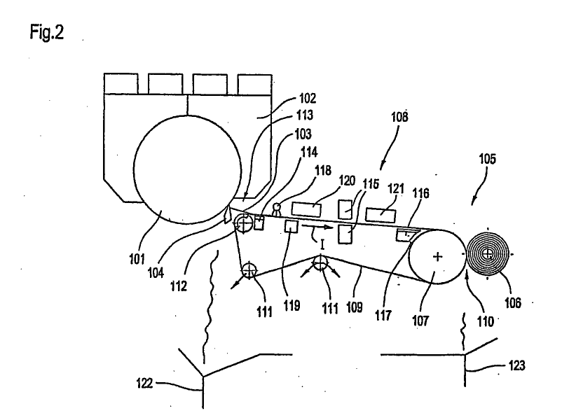

FIG. 2 shows part of a device according to the invention in a second variant,

FIG. 3 shows a schematic illustration of an exemplary embodiment of a tissue machine,

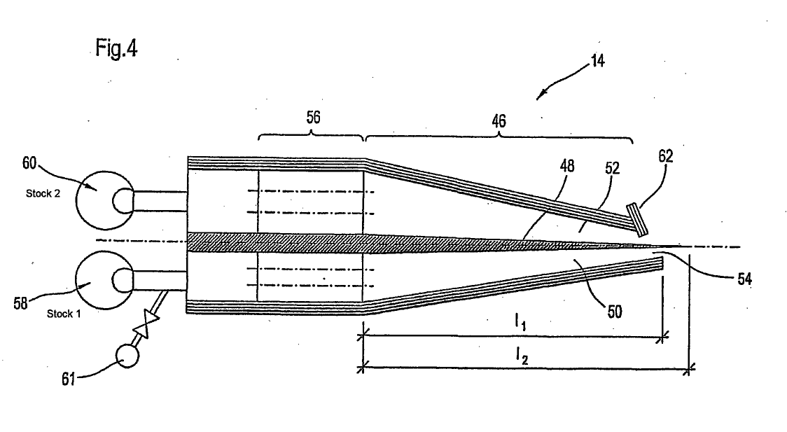

FIG. 4 shows a schematic illustration of an exemplary embodiment of a headbox of a tissue machine,

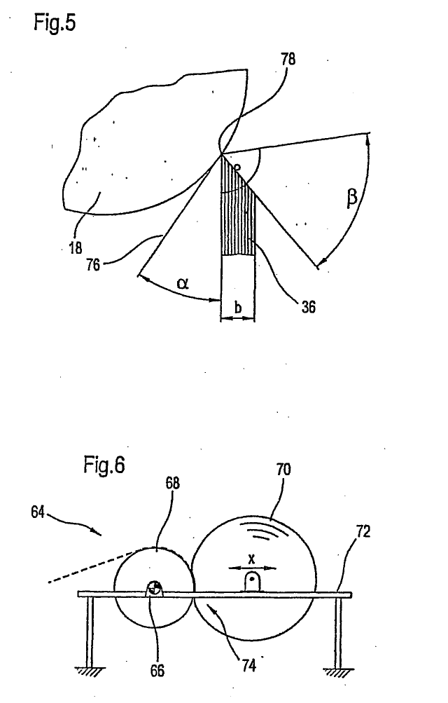

FIG. 5 shows a schematic partial illustration of a creping doctor assigned to the drying cylinder of a tissue machine,

FIG. 6 shows a schematic illustration of a conventional winding device for tissue,

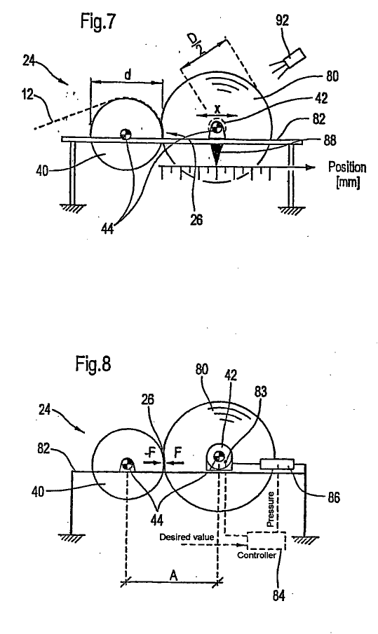

FIG. 7 shows a schematic illustration of an exemplary embodiment of a winding device of a tissue machine with movable, displacement-controlled spool and wound roll,

FIG. 8 shows a schematic illustration of a further exemplary embodiment of a winding device for a tissue machine with movable spool and wound roll with associated pressure and/or force sensors,

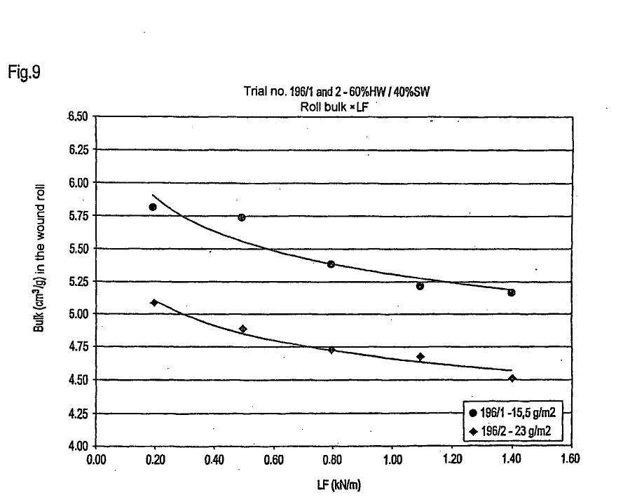

FIG. 9 shows a graph which reproduces the influence of the line force in the winding nip on the specific volume (bulk) of the web of tissue in the wound roll,

FIG. 10 shows a graph which, in comparison with a suction press roll (SPR), reproduces the influence of a shoe press (TF) on the specific volume (bulk) as a function of the line force of the press, what is known as a T-rib Yankee cylinder, i.e. a Yankee cylinder provided with internal reinforcing ribs, being used from 90 kN/m onward,

FIG. 11 shows a graph comparable with the graph of FIG. 8 but in this case for the “hand feel”,

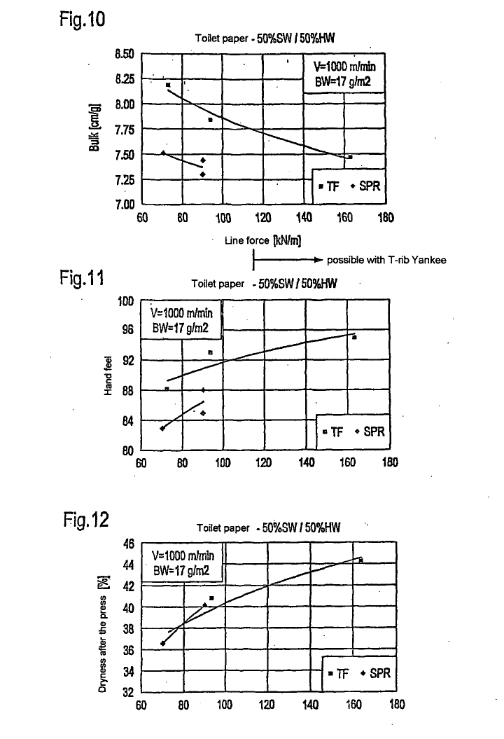

FIG. 12 shows a graph comparable with the graph of FIG. 8 but in this case for the dryness after the press,

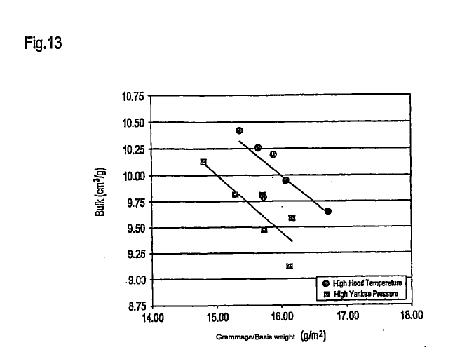

FIG. 13 shows a graph which reproduces the influence of drying conditions, such as in particular the drying ratio Yankee cylinder/drying hood,

FIG. 14 shows a graph which reproduces the influence of the thickness of the creping doctor on the thickness of the tissue paper (bulk), and

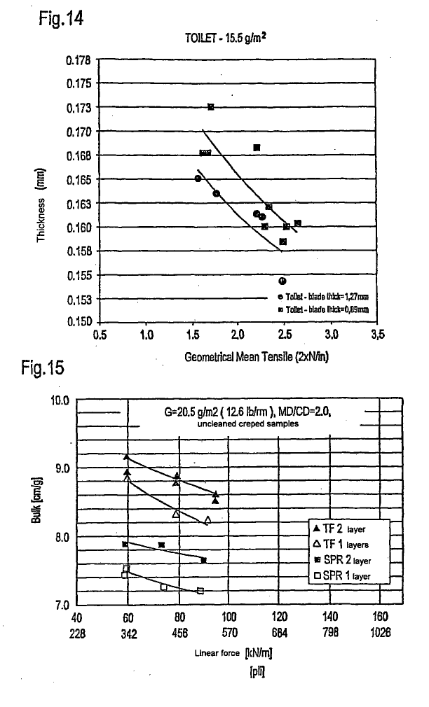

FIG. 15 shows a graph which reproduces the influence of the multilayer production of the tissue paper on the specific volume (bulk) in the case of different presses, it being possible in particular to see the advantage that results when a shoe press (TF) is used as compared with a suction press roll (SPR).

The device illustrated in FIG. 1 comprises a drying cylinder 101, constructed as what is known as a Yankee cylinder, for example, having a drying hood 102 for drying a web of tissue 103 coming from a headbox, as is generally known for the production of webs of tissue. The web of tissue 103 is doctored off the drying cylinder 101 by means of a creping doctor 104 and supplied to a winding device 105, on which the web of tissue 103 is wound up on a spool 106. The web of tissue 103 runs over a winding drum 107, which is pressed against the spool 106. Both the winding drum 107 and the spool 106 can be driven, also at different speeds.

Between the creping doctor 104 and the winding device 105, a transfer device 108 is provided. The transfer device 108 comprises a transfer belt 109, in particular a TAD belt, which, together with the web of tissue 103, is led through the winding nip 110 between winding drum 107 and spool 106. Furthermore, the transfer belt 109 is led over deflection rollers 111 and a roll 112.

The roll 112 is located in the immediate vicinity of the creping doctor 104 and somewhat underneath the latter. As a result, the web of tissue 103 runs onto the transfer belt 109 approximately in the region of the roll 112, so that there is only a short free web draw 113 between creping doctor 104 and transfer belt 109. The web of tissue 103 is thus largely supported on its underside by the transfer belt 109 over the entire distance from creping doctor 104 to winding device 105.

Shortly after the roll 112 and underneath the transfer belt 109 there is arranged a suction box 114, in order to extract remaining moisture from the web of tissue 103. Approximately in the middle between roll 112 and winding device 105, a scanning device 115 is also provided on both sides of the web of tissue 103, in order to determine specific properties of the web of tissue 103 and/or of the transfer belt 109.

A further suction box 116 is arranged immediately before the winding drum 107. It is used to ensure that the web of tissue 103 runs onto the winding drum 107. Furthermore, under the suction box 116, an air doctor 117 is provided on the winding drum 107, by means of which doctor air carried along by the winding drum 107 is led away.

The second variant of a device according to the invention, illustrated in FIG. 2, agrees in the substantial features with the device illustrated in FIG. 1. However, in order to improve the transfer of the web of tissue 103 from the creping doctor 104 onto the transfer belt 109, the roll 112 is constructed as a suction roll here.

Furthermore, in this second variant, a rewetting device 118, for example in the form a wetting shower, is provided after the first suction box 114. Arranged after the rewetting device 118 is a further suction box 119 and also a drying device 120, for example an infrared drying device. A further infrared drying device 121 is arranged after the scanner device 115.

Furthermore, in FIG. 2, a pulper 122 and 123, respectively, is arranged underneath the drying cylinder 1 and also under the winding device 105.

In addition to or instead of the suction roll 112, a blowing device can also be arranged in the region of the roll 112 in order to assist the transfer of the web of tissue 103 onto the transfer belt 109. The winding drum 107 can be uncovered or covered, for example with rubber. In addition, the winding drum can be provided with a smooth shell, a blind-drilled shell, a drilled shell or a shell provided with grooves. Blowing devices can be provided in order to carry away excess paper into the pulpers 122 and 123.

During the operation of the device according to the invention, the web of tissue 103 coming from the headbox is lead over the drying cylinder 101, where the web of tissue 103 is largely dried. The web of tissue 103 is doctored off the drying cylinder 101 by the doctor 104 and then runs with a short free web draw 113 into the transfer belt 109. By using the transfer belt 109, the web of tissue 103 is supplied to the winding device 105 and, after passing through the winding nip 110, is wound up onto the spool 106. In the process, the web of tissue 103 has vacuum applied to it by the suction box 114 and the suction box 116 and is also monitored by the scanner device 115.

In the variant illustrated in FIG. 2, the web of tissue 103 is additionally wetted by the rewetting device 119 and has vacuum applied to it by the further suction box 118. As a result, wet forming of the web of tissue can be carried out. The web of tissue 103 is then brought to a desired dryness again by the drying devices 120 and 121. Both in the case of the drying cylinder 101 and in the case of the winding device 5, excess paper is led away into the pulpers 122 and 123.

In both variants, a patterning process (patterning pressing) is carried out in the winding nip 110 on the basis of the structure of the transfer belt 109. The patterning pressing results from the fact that, in the winding nip 110, the web of tissue 103 is pressed substantially only in the elevated regions of the transfer belt 109 and otherwise remains unpressed or only slightly pressed. In this way, the quality of the web of tissue 103 can be increased, in order to achieve a high specific volume and a good hand feel.

The high quality of the web of tissue is additionally assisted by the line force in the winding nip 110 being reduced according to the invention, in particular to 0.2 kN/m or less. This is made possible, amongst other things, by the free web draw being less than 1 m, in particular less than 0.5 m, on account of the support by the transfer belt 109. On the basis of this refinement, a threading system is likewise not needed.

The creping rate is preferably set to be between about 0% and about 50%, in particular between about 10% and about 25%. The dryness of the web of tissue 103 at the creping doctor 104 is preferably chosen to be between about 70% and about 100%, in particular between 93% and about 98%. However, it is also possible to operate with a moist web of tissue 103.

By means of the device according to the invention, a good quality of the web of tissue 103 can be achieved with a higher production speed and runability of the device at the same time. In addition, the invention is suitable in particular for tissue webs of low basis weight and/or low tensile strength.

FIG. 3 shows an exemplary embodiment of a machine 10 for producing a web of tissue 12 in a schematic illustration.

The tissue machine 10 comprises a headbox 14 and an endless carrier belt 16, with which the web of tissue 12 is led through a press nip 22 formed between a drying cylinder 18, a Yankee cylinder 18 here, and a backing unit 20.

Moreover, the tissue machine 10 comprises a winding device (reeler) 24 for subsequently winding up the web of tissue 12.

The headbox 14 provided is a multilayer headbox, a two-layer headbox in the present case, to which at least two different grades of stock can be supplied.

Furthermore, means described in more detail further below are provided in order to influence, that is to say in particular to control and/or to regulate, the hardness of the roll produced in a predefined way when winding up the web of tissue 12. In this case, the line force produced in the winding nip 26 is preferably kept less than or equal to 0.8 kN/m. A former having two circulating endless belts 16, 28 is provided, one of these two endless circulating belts 16, 28 simultaneously forming the transport belt 16.

As can be seen from FIG. 3, the two endless belts 16, 28 run together, forming a stock inlet gap 30, in order then to be led over a forming element 32, in particular a forming or breast roll. In this case, the wrap angle with respect to the outer belt 28 is smaller than that with respect to the inner carrier belt 16.

In the present case, a Crescent former is provided, whose inner belt (carrier belt) 16 is formed by a felt.

By means of the multilayer headbox 14, different grades of stock, in the present case an HW grade of stock made of fibers from hardwood and an SW grade of stock made of fibers of softwood are introduced into the inlet gap formed between the carrier belt 16 and the outer fabric 28. The hardwood fibers can in particular be short fiber chemical pulps and the softwood fibers can in particular be long fiber chemical pulps.

After the wrap region of the forming roll 32, the web of tissue forming in this case, together with the carrier belt 16, is supplied to the press nip 22 extended in the web running direction L.

Before reaching the extended press nip 22, the carrier belt 16 carrying the web of tissue 12 with it wraps around an evacuated device, designed as a suction roll 34 here. The suction roll 34 removes a substantial part of the water from the carrier belt 16 and even somewhat from the outer web of tissue 12.

The backing unit 20 assigned to the drying cylinder 18 is formed in the present case by a shoe press unit, in particular a shoe press roll. The press nip 22 is therefore an extended press nip of a shoe press comprising the drying cylinder 18 and the shoe press unit 20.

A creping doctor or bar 36, in particular a thin creping doctor or bar, is assigned to the drying cylinder 18.

Following the press nip 22, the web of tissue 12 is led around the drying cylinder 18. In this case, a drying hood 38 is provided in order to intensify the drying in the relevant wrap region.

As can be seen from FIG. 3, a measuring frame 39 is provided between the drying cylinder 18 and the winding device 24. In this case, the measured values obtained can, for example, also be used for transverse profile regulation of specific web properties.

In the winding device 24, the web of tissue 12 is led first over a carrier drum 40 and then wound up onto a spool 42. Here, preferably both the carrier drum 40 and the spool 42 are each assigned a separate drive 44.

As can be seen from FIG. 3, the HW grade of stock made of short fibers obtained from hardwood is used for the layer Y facing the surface of the drying cylinder 18, and the grade of stock made of long fibers obtained from softwood is used for the layer provided on the opposite web side.

FIG. 4 shows an exemplary embodiment of the headbox 14 of the tissue machine according to the invention in a schematic illustration. In this case, the nozzle 46 of this headbox 14 is subdivided at least substantially into two channels 50, 52 by a slat 48 extending over the entire machine width. The slat 48 extends outward beyond the nozzle 46 in the region of the outlet gap 54. The quantity of the slat 12 measured downstream of the turbulence generator 56 of the headbox 14, as is the nozzle length l₁, is therefore greater than the nozzle length l₁.

Moreover, the transverse distributor pipes 58, 60 for the two grades of stock can be seen in FIG. 4.

In the present case, moreover, sectional dilution water regulation and/or control is provided over the machine width only for the layer facing the forming roll 32 (cf. FIG. 3). In FIG. 4, a transverse distributor pipe 61 for dilution water, for example, can be seen.

In the region of the outlet gap 54 of the nozzle 46, one or more slices 62 can be provided. However, such slices are not imperative.

The proportion of the drying provided by the drying hood 38 for drying the web of tissue 12 is preferably greater than the proportion of the drying provided by the drying cylinder 18.

FIG. 5 shows a creping doctor 36 assigned to the drying cylinder or Yankee cylinder 18 of the tissue machine 10 according to the invention (cf. FIG. 3) in a schematic partial illustration.

In the present exemplary embodiment, illustrated in FIG. 5, the thickness b of the creping doctor 36 is less than or equal to 0.9 mm. The angle of attack or clearance angle between the tangent 76 to the drying cylinder 18 going through the point of contact 78 and the creping doctor 36 is less than or equal to 20°. The “rake angle” of the creping doctor 36, designated “ ” in FIG. 3, can in particular be greater than or equal to 15°.

FIG. 6 shows a conventional winding device 64 for tissue in a schematic illustration, in which the carrier drum 68 provided with a drive 66 is pressed against the wound roll 70 onto which the web of tissue produced is wound, which means that the wound roll 70 is driven. The carrier drum 68 is fixed in location. The wound roll 70 can be moved on rails 72. The contact pressure force must be sufficiently large for the necessary drive power to be transmitted. The line force produced in the winding nip 74 is around 0.8 kN/m (width). The line force is in this case so high that the carrier drum 68 dips into the soft wound roll 70 and thus destroys or reduces the specific volume (bulk). The diameter growth of the wound roll 70 is taken into account by moving the wound roll 70 away from the carrier drum 68.

FIGS. 7 and 8 show two exemplary embodiments of the winding device 24 according to the invention in a schematic illustration.

In the respective winding device 24, the web of tissue 12 is led over a carrier roll 40 and then wound up onto a spool 42. In both embodiments, both the carrier drum 40 and the spool 42 are each assigned a drive 44.

Between the roll or wound roll 80 forming on the spool 42 and the carrier drum 40, a winding nip or contact nip 26 is formed, in which a line force is produced which critically influences the resultant winding hardness. At least the spool 42 can be moved in the x-direction, that is to say for example horizontally, on rails 82 or the like.

The embodiment of the winding device 24 shown in FIG. 8 is an example of one possible solution for the regulation of the line force.

In the present case, the carrier drum 40 is mounted in a fixed location on the rails 82. By contrast, the spool 42 and, in a corresponding way, the wound roll 80 formed thereon, can move or can be moved. In this case, the spool 42 can be changed in its position, for example by means of translational actuators provided on both sides, such as threaded rods with associated motor, hydraulic cylinders, and so on.

Preferred criteria for the translation or displacement of the spool 42 and the roll 80 formed thereon are the growth in the roll diameter D and the line force in the winding nip 26.

In this embodiment, both criteria can be satisfied with one control loop.

Sensors 83, which measure the nip force F in the region of the press nip 26 directly or indirectly can be integrated in the bearings of the spool 42. The aforementioned sensors can be, for example, pressure sensors, force sensors, strain gages and so on.

If, for example, the measured force deviates from the predefined force, that is to say a corresponding desired value, then the pressure of a relevant hydraulic cylinder, for example, is changed via a controller 84, for example by a hydraulic unit, in such a way that the difference between the desired value and the measured value becomes “zero”.

Of course, a modification of this embodiment in which only the carrier drum 40 or both the carrier drum 40 and the spool 42 can be moved or displaced is also conceivable. In the case of a movable carrier drum 40, this has the relevant sensors via which the nip force F is regulated.

The displacement of the wound roll in this case compensates only for the growth in the roll diameter D.

The distance between the axes of the carrier drum 40 and the spool 42 or the wound roll 80, which becomes increasingly larger during the winding operation, is designated “A” in FIG. 8.

In the case of low line forces and large, heavy wound rolls, it is possible for the case to occur in which the measurement accuracy of the sensors and the setting accuracy (friction) are no longer adequate.

In particular in the case of line forces in the winding nip 26 which are less than or equal to 0.5 kN/m and in particular less than or equal to 0.2 kN/m, for example the movable spool and, in a corresponding way, the wound roll 80 formed thereon are preferably designed to be displacement-controlled. The design shown in FIG. 5 is an appropriate embodiment.

The measured variables provided for this displacement control are in particular the following variables:
diameter D of the wound roll 80
position of the wound roll 80 or of the spool 42 relative to the carrier drum 40.

In this case, the position of the wound roll 80 can be measured by sensors such as LVDTs (linear variable differential transformer), and the diameter of the wound roll can be determined by a distance sensor, for example optically or acoustically. The actuators 86 (cf. FIG. 6), which can be hydraulic cylinders and so on, for example, position the wound roll 80 accurately in such a way that, for example, the latter just touches the carrier drum 40. In this case, the line force F_{L} produced in the winding nip 26 is therefore equal to zero. If F_{L} is to be >0 kN/m, then the wound roll 80 can be moved further onto the carrier drum 40 by a predefinable distance which, in particular, depends on the softness of the wound roll 80. This therefore produces a slight desired pressure in the press nip or contact nip 26 of, for example, F_{L}≦0.2 kN/m. The distance A (cf also FIG. 6) is therefore A<d/2+D/2 or A=d/2+D/2−x, where “x” is a measure of the extent to which the carrier drum 40 dips into the roll 80 formed on the spool 42.

A further possible way of monitoring and setting the nip force results, for example, from observing the nip region with a CCD camera. Therefore, in particular the distance between the carrier drum 40 and the wound roll 80 can be measured and displayed. By using an appropriate evaluation of the image obtained, a desired value, for example for a hydraulic cylinder pressure, can then again be calculated and effect the displacement as far as the desired distance or nip force via a control device. The gain in bulk lies in a range from 4 to 8%.

In order to illustrate the displacement control, in the illustration according to FIG. 7, the spool 42 is assigned a pointer 88, whose position with respect to a stationary scale 90 ultimately indicates the position of the spool 42 and therefore of the roll 80 formed on the latter.

Moreover, in FIG. 7 it is possible to see a sensor 92 which, in particular, is a sensor of the type mentioned previously, for example only a CCD camera or the like.

FIG. 9 shows a graph which reproduces the influence of the line force L_{F} in the winding nip on the specific volume (bulk) of the web of tissue in the wound roll. “HW” designates a grade of stock made from hardwood fibers, and “SW” designates a grade of stock made from softwood fibers.

FIG. 10 shows a graph which, in comparison with a suction press roll (SPR), reproduces the influence of a shoe press (TF) provided according to the invention on the specific volume (bulk) as a function of the line force of the press. In this case, beginning at 90 kN/m, what is known as a “T-rib” Yankee cylinder, that is to say a Yankee cylinder provided with internal reinforcing ribs, is used.

FIG. 11 shows a graph comparable with the graph of FIG. 10, but in this case for the “hand feel” already mentioned at the beginning.

FIG. 12 also again shows a graph comparable with the graph of FIG. 10, but in this case for the dryness after the press.

The graph of FIG. 13 reproduces the influence of drying conditions, such as in particular the drying ratio Yankee cylinder/drying hood.

The graph of FIG. 14 shows the influence of the thickness of the creping doctor on the thickness of the tissue paper, which here corresponds to the specific volume (bulk). On the other hand, an improved “hand feel” value at a constant “bulk” value is also possible. In the graph, the abbreviation “GMT” stands for the English expression “geometric mean tensile” (geometric average of the strength).

FIG. 15 shows a graph which reproduces the influence of the multilayer production of the tissue paper on the specific volume (bulk) in the case of different presses, it being possible in particular to see the advantage that results with the use of a shoe press (TF) as compared with a suction press roll (SPR).

### LIST OF DESIGNATIONS

10 Tissue machine
12 Web of tissue
14 Headbox
16 Endless circulating belt, carrier belt
18 Drying cylinder, Yankee cylinder
20 Backing unit, shoe press unit
22 Press nip, contact nip
24 Winding device, reeler
26 Winding nip
28 Endless circulating belt, outer fabric
30 Stock inlet gap
32 Forming element, forming roll, breast roll
34 Evacuated device, suction roll
36 Creping doctor, doctor bar
38 Drying hood
39 Measuring frame
40 Carrier drum
42 Spool
44 Drive
46 Nozzle
48 Slat
50 Channel
52 Channel
54 Outlet gap
56 Turbulence generator
58 Transverse distributor pipe
60 Transverse distributor pipe
61 Transverse distributor pipe
62 Slice
64 Winding device, reeler
66 Drive
68 Carrier drum
70 Wound roll
72 Rails
74 Winding nip
76 Tangent
78 Point of contact
80 Roll, wound roll
82 Rails
83 Sensor
84 Controller
86 Actuator
88 Pointer
90 Scale
92 Sensor
101 Drying cylinder
102 Drying hood
103 Web of tissue
104 Creping doctor
105 Winding device
106 Spool
107 Winding drum
108 Transfer means
109 Transfer belt
110 Winding nip
111 Deflection roller
112 Roll
113 Free web draw
114 Suction box
115 Scanner device
116 Suction box
117 Air doctor
118 Rewetting device
119 Suction box
120 Infrared drying device
121 Infrared drying device
122 Pulper
123 Pulper
l Web running direction
A Distance
D Roll diameter
F Nip force, force in the winding nip
b Thickness
l₁ Nozzle length
l₂ Slat length
α Angle of attack, clearance angle
β “Rake angle”

1-159. (canceled)

160. A method for producing a web of tissue, in which the web of tissue is led over at least one drying cylinder, doctored off the latter with a creping doctor and then wound up by means of a winding device, wherein the web of tissue is supported at least largely over the entire distance between creping doctor and winding device on one side by a transfer means, so that there is only a short free web draw, while its other side is free.

161. A device that produces a web of tissue, comprising at least one drying cylinder, a creping doctor arranged on the drying cylinder and a winding device that winds up the web of tissue wherein between the creping doctor and winding device, a transfer means that at least largely bridges the entire distance is provided which supports the web of tissue on one side, so that there is a short free web draw, but leaves its other side free.
